(19) United States
(12) Patent Application Publication
(10) Pub. No.: US 2025/0121299 A1
(43) Pub. Date: Apr. 17, 2025

(54) EXTRACTOR

(71) Applicant: CPM WOLVERINE PROCTOR LLC, Lexington, NC (US)

(72) Inventors: Benjamin E. Floan, Andover, MN (US); Nicholas Ollila, Fridley, MN (US); Jeffrey K. Garritsen, Forest Lake, MN (US); George E. Anderson, Champlin, MN (US)

(73) Assignee: CPM WOLVERINE PROCTOR LLC, Lexington, NC (US)

(21) Appl. No.: 18/484,578

(22) Filed: Oct. 11, 2023

(51) Int. Cl. B01D 11/02; B01D 11/00; B01D 11/04

(52) U.S. Cl. CPC B01D 11/0253; B01D 11/0284; B01D 11/0492; B01D 2011/002; B01D 2221/06

(57) ABSTRACT

An extractor with a housing, conveyor assembly, and a plurality of recycle stages which are configured to direct a flow of solvent or miscella upwardly through a material bed.

### FIELD

This disclosure relates to solvent extraction and, more particularly, to liquid-solvent extractors.

### BACKGROUND

Extractors are usable in a variety of contexts and are particularly applicable for use in processing agricultural products. In some applications, granular or flake material is treated with a solvent so that some amount of a component of the granular or flake material is dissolved by the solvent in solution and separated. Soybean flakes are one example of a product for which an extractor is utilized to process. Such flakes are typically treated with a solvent such as hexane. The solvent dissolves and separates, or extracts oil in the flakes.

Soy protein concentrate can also be processed with an extractor to remove carbohydrates from the material. De-fatted soybean flakes are washed with an alcohol-water solvent to dissolve and separate carbohydrates from the flakes to produce a flake material with a higher concentration of protein.

In known extractors, granular or flake material is transported from the extractor inlet to the extractor outlet. A drag conveyor may be incorporated into the extractor to transport the granular or flake material. Generally, while solvent is poured over a bed of the material, the material is transported from the extractor inlet to the extractor outlet. The efficiency of the extractor is the measure of the rate at which the solvent is able to effectively remove the targeted component from the material.

The bed of granular or flake material being conveyed is essentially a porous medium. Consequently, as solvent is repeatedly poured onto the top of the bed, it washes through the bed, making contact with the material, and draining out through a screen supporting a bed of the material. In an application previously discussed, the hexane wash (solvent) drains through a slurry of oil-impregnated soybean material (granular or flake material slurry), also described as a bed of material, as it is conveyed with in the extractor. The included oil is, thereby, removed from the soybean material (e.g., for subsequent processing).

Generally, the geometry of the material bed from which an included component is being extracted (e.g., oil) is not, however, uniform. At various locations within the bed, variation in efficiency will be realized. Some locations within the bed are more open, and some locations are more packed. This can be true for various types of granular or flake material. Consequently, in zones that are more open, there will be a greater flow of solvent than in other locations. In locations where there is less solvent flow, greater extraction time will be necessary.

Regardless of the application in which an extractor is used, manufacturers and operators of extractors are continuously looking for ways to improve the economic efficiency of their extractor operation.

### SUMMARY

Various concepts in this patent specification relate to, among other things, improved extractor efficiency through pumping of solvent in a countercurrent fashion to feedstock material in order to help thoroughly communicate solvent through the feedstock and accelerate extraction processes.

Various design concepts of this patent specification relate to an extractor that includes a housing, a conveyor assembly, and a plurality of recycle stages. In some embodiments, a solvent is pumped upward through the conveyor assembly as it moves through the housing. In various implementations, upward trajectory of recycle flow advantageously helps to accelerate the extraction by more thoroughly communicating solvent through the bed of material subject to extraction, for example.

In one Example, the present disclosure provides an extractor, comprising a housing having a solids material inlet, a solvent inlet, a solids material outlet, and a solvent/miscella outlet, the housing including a feed portion configured to receive a solids material, and an immersion portion configured to maintain a liquid pool in which the solids material is immersible during operation of the extractor; a conveyor assembly extending from the feed portion to the immersion portion, the conveyor assembly configured to transmit the solids material from the feed portion to the immersion portion within the extractor housing; a plurality of recycle stages within the immersion portion, wherein each stage is optionally separated by a divider, and wherein each stage has a solvent and/or miscella recycle inlet positioned to direct a flow of solvent and/or miscella upwardly into the immersion portion wherein the solvent and/or miscella intermixes with the solids material; and optionally, a further solvent and/or miscella recycle outlet.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an isometric view of an extractor.

FIG. 2 is an isometric sectional view an extractor.

FIG. 3 is an isometric sectional view of an extractor's arrowhead assembly.

FIG. 4 is an isometric view of one of the extractor's inlet whistles.

FIG. 5 is an isometric sectional view of a portion of the solvent handling system of an extractor.

FIG. 6 is an isometric sectional view of an extractor's scupper.

FIG. 7 is an isometric view of the lower portion of an extractor's housing.

### DETAILED DESCRIPTION

In general, the disclosure relates to liquid-solid countercurrent extraction processes that enable the extraction of one or more desired products from solid material flows, also described as a bed of material. In some examples, an extractor conveys a continuous flow of solid material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 5 minutes to 2 hours, such as 10 minutes, 30 minutes, 1 hour, 2 hours, or within any range encompassed by these values as endpoints.

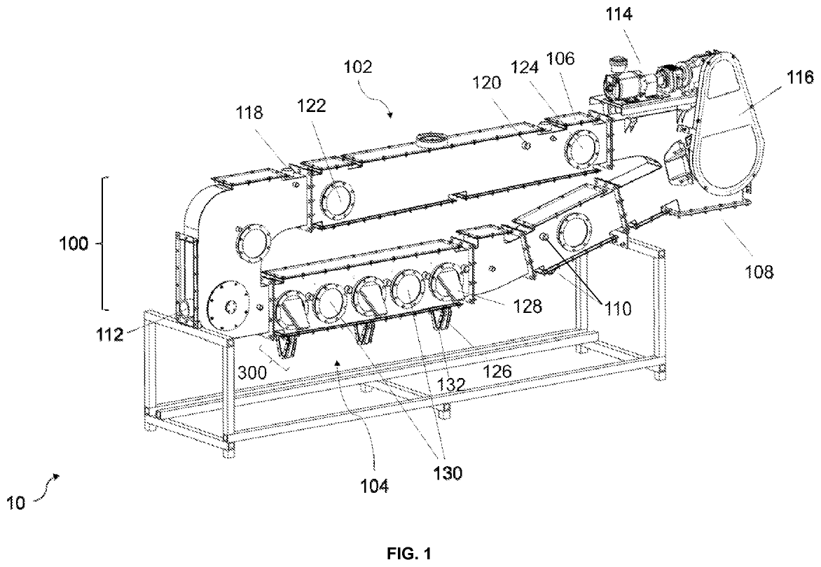

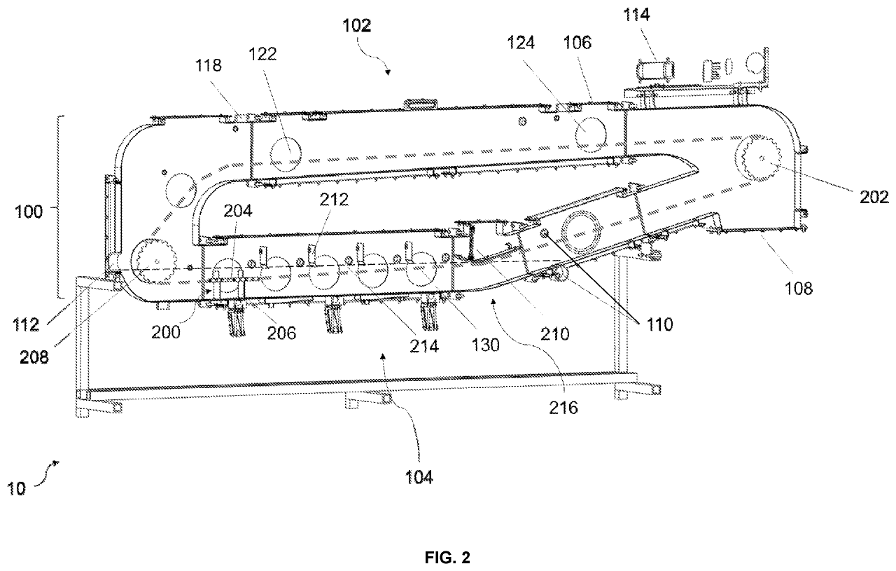

Referring to the drawings wherein like reference numerals denote like elements throughout the several views, FIG. 1 is an isometric view of an extractor 10. As shown, the extractor 10 has a housing 100 which is coupled to a conveyor system 200 and a solvent handling system 300. FIG. 2 is an isometric view of the Z-axis cross section of extractor 10 showing the features in the interior of housing 100.

### Housing

Referring to FIGS. 1 and 2, the housing 100 has an upper portion 102, and a lower portion 104. In some embodiments, the solid material for extraction is supplied in a continuous flow from a solid material source into the solids material inlet 106. The solids material is conveyed from inlet 106 through the extractor using the conveyor system 200 towards the solids material outlet 108. The upper portion 102 also has a vent 118, upper portion weir 120, and view ports 122 and 124. The vent 118 and upper portion weir 120 are configured to provide flow control in the reactor by maintaining an appropriate level of backpressure inside the housing 100. The lower portion 104 of extractor 10 also has a solvent inlet 110 and a solvent outlet 112. The lower portion 104 is also equipped with multiple viewports 130 to allow a user to observe the inside of the extractor. The lower portion 104 of the extractor also has an inclined drain section 216 where the solids material starts to rise above the solvent pool (designated generally in FIG. 2 by solvent line 214).

### Conveyor Assembly

In some embodiments, the housing 100 is coupled to the conveyor system 200 which generally includes a chain 204 that connects to paddles 206. In FIG. 2, only a section of the chain 204 and paddles 206 are shown to avoid obfuscating features of the extractor 10. A remainder of the path of the chain 204 is shown in broken lines extending in a continuous circuit between the upper portion 102 and the lower portion 104. Though not shown, the conveyor system 200 has repeating chain and paddles which loop around through the entire housing 100 along the path indicated by the broken line in FIG. 2. In some embodiments, the upper portion 102 of extractor 10 has an external drive motor 114 which is coupled to the conveyor assembly 200 via drive sprocket assembly 116. The conveyor assembly is driven by internal drive sprocket 202, which connects to chain 204 (not shown) and is powered by the external drive motor 114. The conveyor assembly also loops around internal idler sprocket 208. Tensioner 210 can be adjusted to apply greater or lesser downward pressure to the conveyor assembly 200 for maintenance and to keep chain 204 firmly seated on sprockets 204 and 208 during operation.

### Solvent Handling

In some embodiments, the housing 100 is coupled to solvent handling system 300 which sits in the lower portion 104 of the housing. The solvent handling system 300 includes a solvent pool, the top of which is indicated generally by solvent line 214. The solvent handling system 300 includes arrowhead assembly 126 and scupper 128 (FIG. 1). The system 300 also includes several stage separation baffles 212 which are positioned slightly within and above the solvent line 214. The tip of scupper 128 has a solvent outlet 130 which points downwards. The bottom side of arrowhead assembly 126 has a solvent inlet 132 (FIG. 1).

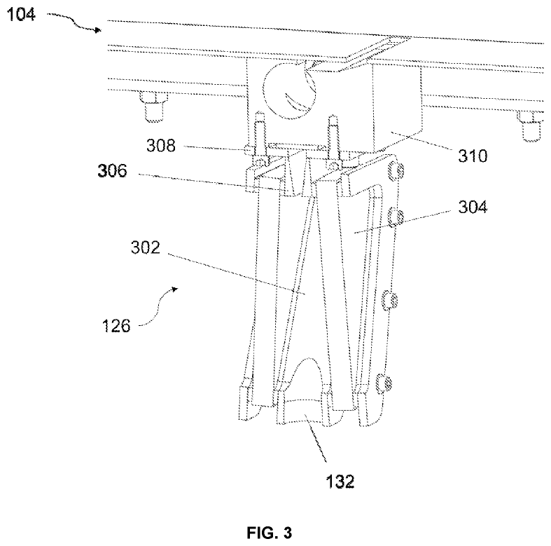

FIG. 3 is an isometric view of arrowhead assembly 126 showing a longitudinal section of the assembly 126. Distribution manifold 302 has a solvent inlet 132 at the bottom. The distribution manifold is configured such that solvent generally flows in an upward direction from the solvent inlet 132 towards the lower portion 104 of the housing. In some embodiments, the sides of the distribution manifold are glass panels 304 which act as viewports. The arrowhead cover 306 has a tapered shape that opens upwards into inlet whistle plate 308 which is bolted to the inlet whistle block 310. As shown, the tapered shape increases in width from the solvent inlet 132 to inlet whistle plate 308 providing optimum flow distribution into the inlet holes of the whistle block. The arrowhead shape provides uniform flow distribution and promotes mixing of entrained solids. This allows solids to stay entrained as the solvent is recycled, allowing the solids to be re-injected back into the extractor.

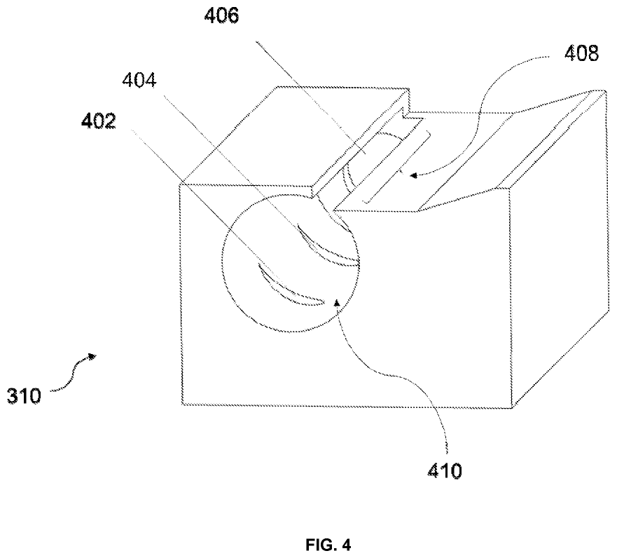

FIG. 4 is an isometric view of an isolated inlet whistle block 310. The inlet whistle block 310 has a manifold 410 (e.g., in the shape of a cylinder) in the middle with round holes 402 and 404. Holes 402 and 404 pass through to the underside of the inlet whistle block 310 and connect underneath to the opening in the top of arrowhead cover 306, allowing solvent to pass through. The top of the inlet whistle block 310 has an elongate mouth 408 that runs parallel to its length. Elongate mouth 408 opens into the lower portion 104 of the housing above. The inlet whistle block 310 also has an opening (e.g., round hole) 406 at the back which is needed only for fabrication of the whistle. After the whistle is joined to the lower cover, opening 406 is sealed shut such that the only holes that have liquid communication are 404, 402, and 408.

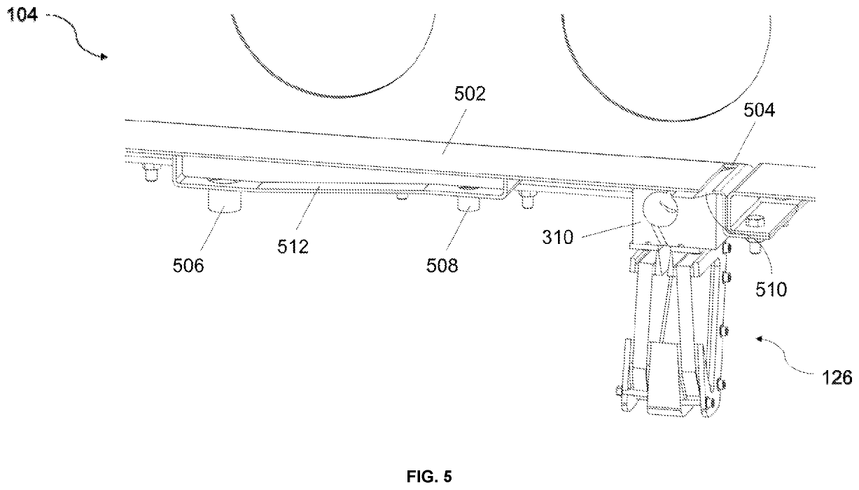

FIG. 5 is an isometric view of a longitudinal section of a portion of the lower housing 104 and arrowhead assembly 126. The bottom plate 502 of the lower housing 104 has a mouth 504 which opens into an elongate recess 510 at the top of inlet whistle block 310. This opening fluidly couples the arrowhead assembly 126, the inlet whistle block 310, and the lower housing 104. Openings 506 and 508 allow steam or another warm fluid to enter chamber 512 for heating of the lower portion of the extractor's housing. Chamber 512 is not in fluid communication with the extractor's housing.

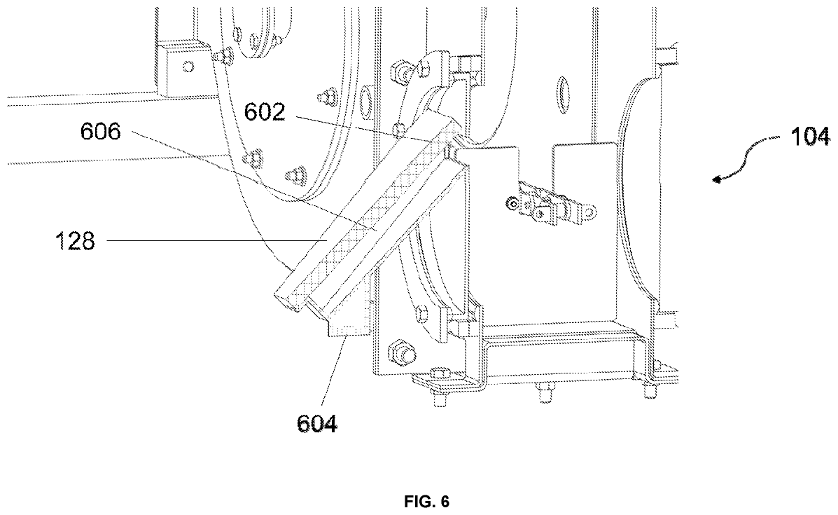

In some embodiments, the solvent handling system 300 includes solvent recycle stage that allows for solvent to be drained away from the solvent pool then pumped back into the lower housing. FIG. 6 is an isometric view of an X-axis cross section, or transverse section, of a portion of the lower housing 104. The cross-section slices through scupper 128 showing a hollow channel 606 on the inside. The scupper has an inlet 602 which opens into the inside of lower housing 104 and an outlet 604 which is open to the outside of the extractor 10 (FIG. 1).

### Extractor Operation

As shown in FIGS. 1-6, the extractor 10 generally includes a feed portion which includes the components of the upper housing 102 and an immersion portion which includes the components of the lower housing 104. The feed portion is configured to receive and convey a solids material through the extractor to the immersion portion. The immersion portion, in turn, is configured to maintain a solvent pool in which the solids material is immersed and subjected to counterflow of solvent during operation of the extractor 10.

During operation of extractor 10, solids material enters through solids material inlet 106. Once inside the feed portion, the solids material (not shown) is picked up by the conveyor assembly 200 and carried towards the immersion portion for extraction.

In the immersion portion, the solids material comes into contact with the solvent pool which fills the lower housing 104 up to line 214. In some embodiments, the solids material remains completely submerged in the pool of solvent as it travels through at least the lower housing 104 of the extractor, or it may be submerged as it travels through substantially all of the extractor 10 (e.g., except when adjacent to solids inlet 106 and solids outlet 108).

The speed of the conveyor assembly may be tuned to adjust the rate of travel of the solids material through the solvent pool. As different solids materials will have extractants that dissolve at different rates, a user may adjust the conveyor speed to optimize extraction. In preferred embodiments, the speed of the conveyor is from 0.125 ft/min to 2.5 ft/min.

The contact time between the solids material and solvent may be from 600 seconds to 6000 seconds.

The extractor 10 can process any of a variety of desired solids materials using any of a variety of suitable solvents. Solids material that may be processed in extractor 10 includes oleaginous matter, such as soybeans (and/or soy protein concentrate), hemp, rapeseed, sunflower seed, peanuts, cottonseed, palm kernels, and com germ; oil-bearing seeds and fruits; asphalt-containing materials (e.g., asphalt-containing roofing shingles that include an aggregate material such as crushed mineral rock, asphalt, and a fiber reinforcing); stimulants (e.g., nicotine, caffeine); alfalfa; almond hulls; anchovy meals; bark; coffee beans and/or grounds, carrots; chicken parts; chlorophyll; diatomic pellets; fish meal; hops; oats; pine needles; tar sands; vanilla; and wood chips and/or pulp. Solvents that can be used for extraction of the solids material include, but are not limited to, acetone, hexane, toluene, isopropyl alcohol, ethanol, other alcohols, and water.

As referenced above, to provide a flow of solvent passing through extractor 10, the extractor 10 is equipped with a solvent inlet 110 that receives solvent devoid of extract or having a comparatively low concentration of extract. A solvent outlet 112 is provided on a generally opposite end of the housing 100 to discharge solvent having passed through extractor 10. Solvent outlet 112 may be placed advantageously within the immersion and/or feed portion. In some embodiments it may be placed substantially at the level of the solvent line 214. As solvent travels through the housing 100 from inlet 110 to outlet 122, the solvent flows in a countercurrent direction from the flow of solids material passing through the extractor 10. The solvent intermixes with solids material, causing the extract carried by the solids material to transfer from the solids material to the solvent. Accordingly, in operation, solvent having a comparatively low concentration of extract enters at inlet 110 while solvent having an increased concentration of extract discharges at outlet 112. Likewise, fresh solids material carrying extract enters at inlet 106 while processed solids material having a reduced concentration of extract is discharged at outlet 108.

In some embodiments, the extractor includes an inclined drain section 216 located between the lower housing portion 104 and the solids material outlet 108 and configured to allow solvent drainage from the solids material. For example, in instances where solids material is an oil-bearing material, solvent can extract oil out of the solids material forming a miscella (the solution of oil in the extraction solvent) that is discharged through solvent outlet 112.

In some embodiments, the extractor may include a plurality of recycle stages, wherein each stage is optionally separated by a divider. In some embodiments, the divider may include a stage separation baffle 212 which maximizes recycle-liquid containment. The extractor may have three, four, five, or six stages.

FIGS. 3, 5, 6, and 7 illustrate cross sectional view of several components in the solvent/miscella recycling system. Referring to the drawings shown therein, scupper 128 has a solvent and/or miscella recycle outlet 504 at its bottom end. This outlet connects to the pool of solvent and allows solvent to be flow out from the immersion portion of the extractor. Scupper 128 may be configured as an overflow weir in fluid communication with the immersion portion of the housing 100. The openings are typically positioned below the solvent line 214. The solvent and/or miscella recycle outlet 504 controls downwards drainage from the solvent pool. The drained solvent and/or miscella can then be conveyed upwards back into the material bed in each of the recycle zones. The continuous circulation of solvent away from the top of the solvent line 214 into the bottom of the material bed promotes turbulent mixing of the solids material and the solvent.

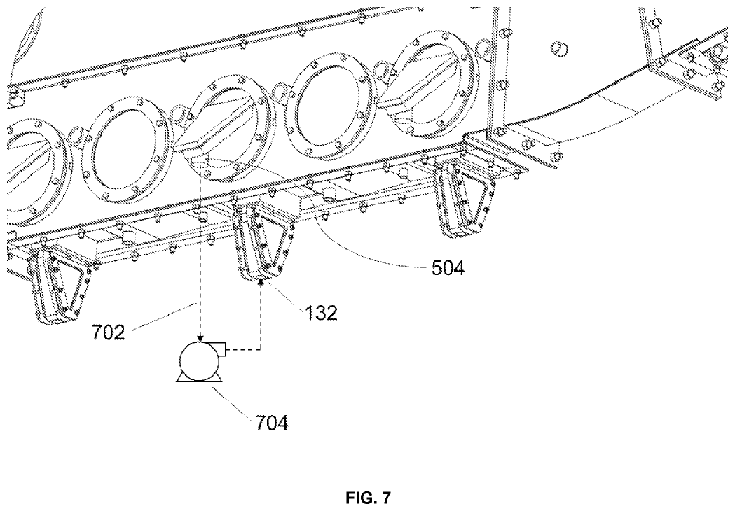

In some embodiments, outlet 504 may be a suction outlet connected to an external pump 704 (FIG. 7) which conveys solvent from solvent/miscella outlet 504 to solvent/miscella recycle inlet 132 at the bottom of arrowhead assembly 126 via recycle line 702. Pump 704 pressurizes the solvent/miscella recycle line to create a continuous circulation of solvent/miscella through the solids material bed. If advantageous, the recycle inlets can be placed at locations in a desired array.

The speed of pump 704 may be adjusted to fine tune the injection rate of the solvent into the solids material bed. In preferred embodiments, the injection rate of the solvent may be optimized for typical solvent to feed (S:F) ratios as required for the extraction, such as from 1:1 to 3:1.

The solvent then rises through distribution manifold 302 and into the inlet whistle block 310. From inlet whistle block 310, miscella or solvent is injected upward into the solids material bed on the conveyor. The wide mouthed design of inlet whistle block 310 creates a wide stream of solvent/miscella which treats a substantial portion of, or the entire width of the material bed or more. This wide jet stream of solvent/miscella promotes turbulent mixing of the solids material in the solvent pool which results in increased extraction. Such a construction helps solvent to be delivered to areas of the bed that may not be washed well by a typical extractor as known in the prior art.

As flow emanates upwardly from arrowhead assembly 126, it will disperse into the material bed. Effective height of the solvent penetration from the inlet is a function of drainage rate of the outlets, the rate and pressure of flow out of the weir 120, the speed of conveyor assembly 200, and the porosity of the material bed.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

What is claimed is:

1. An extractor, comprising:
a housing having a solids material inlet, a solvent inlet, a solids material outlet, and a solvent/miscella outlet, the housing including a feed portion configured to receive a solids material and an immersion portion configured to maintain a liquid pool in which the solids material is immersible during operation of the extractor;
a conveyor assembly extending from the feed portion to the immersion portion, the conveyor assembly configured to transmit the solids material from the feed portion to the immersion portion within the extractor housing;
a plurality of recycle stages within the immersion portion, wherein each stage is optionally separated by a divider, and wherein each stage has a solvent and/or miscella recycle inlet positioned to direct a flow of solvent and/or miscella upwardly into the immersion portion wherein the solvent and/or miscella intermixes with the solids material; and
optionally, a further solvent and/or miscella recycle outlet.

2. The extractor of claim 1, wherein the housing includes an upwardly angled section located between the immersion portion of the housing and the solids material outlet and configured to allow solvent drainage from the solids material.

3. The extractor of claim 1, wherein the conveyor assembly includes a chain with flights driven by an internal drive sprocket, and wherein the chain is guided by an idler sprocket and a guide rail.

4. The extractor of claim 1, wherein the solvent and/or miscella recycle inlets comprises a whistle inlet and a distribution manifold.

5. The extractor of claim 1, wherein the solvent and/or miscella recycle outlet is configured as an overflow weir and/or a suction outlet in fluid communication with the immersion portion of the housing.

6. The extractor of claim 1, wherein the conveyor assembly is configured to move the solids materials in a countercurrent direction relative to a solvent flow.

7. The extractor of claim 1, wherein the solids material inlet and an upper section solvent inlet are positioned to initially rinse the solids material in the feed portion of the housing, the feed portion of the housing being positioned above the immersion portion of the housing.

8. The extractor of claim 1, wherein the divider includes a stage separation baffle.

9. The extractor of claim 1, wherein the extractor has from three to six stages.

10. A method of recovering an extract using an extractor according to claim 1, the method comprising:
contacting the solids material including the extract with solvent in the extractor; and
separating the solvent from the extract.

11. The method of claim 10, wherein the material is selected from the group consisting of soybeans, soy protein concentrate, rapeseed, sunflower seed, hemp, peanuts, cottonseed, palm kernels, com germ, roofing shingles that include an aggregate material such as crushed mineral rock, asphalt, and a fiber reinforcing, nicotine, caffeine, alfalfa, almond hulls, anchovy meals, bark, coffee beans, coffee grounds, carrots, chicken parts, chlorophyll, diatomic pellets, fish meal, hops, oats, pine needles, tar sands, vanilla, wood chips and wood pulp.

12. The method of claim 10, wherein the solvent is selected from the group consisting of acetone, hexane, toluene, isopropyl alcohol, ethanol, and water.

13. The method of claim 10, wherein the solvent is at a temperature of from 35° C. to 90° C.

14. The method of claim 10, wherein the contact time between the material and solvent is from 600 seconds to 6000 seconds.
